(19) United States
(12) Patent Application Publication
(10) Pub. No.: US 2019/0238029 A1
(43) Pub. Date: Aug. 1, 2019

(54) ROTATING ELECTRICAL MACHINE

(71) Applicant: HONDA MOTOR CO., LTD., Tokyo (JP)

(72) Inventor: Kaoru Kajikawa, Wako-shi (JP)

(21) Appl. No.: 16/254,634

(22) Filed: Jan. 23, 2019

(30) Foreign Application Priority Data
Jan. 29, 2018 (JP) 2018-012537

(51) Int. Cl. H02K 9/19; H02K 1/32; H02K 21/14

(52) U.S. Cl. CPC H02K 9/19; H02K 21/14; H02K 1/32

(57) ABSTRACT

A rotating electrical machine includes a tubular stator on which a coil is mounted, a rotor which is configured to be rotatable on an inner side in a radial direction with respect to the stator and has a rotor inner flow path through which a refrigerant can flow, and a refrigerant supply flow path which is provided in the rotor and through which a refrigerant flows from an inner side to an outer side in the radial direction as the rotor rotates. The refrigerant supply flow path includes a first flow path which communicates with the rotor inner flow path, and a second flow path which extends from the first flow path to an outer side in the radial direction and has a discharge port opening at an end portion in an axial direction of the rotor. A refrigerant adjustment section which adjusts a discharge amount of the refrigerant discharged from the discharge port by reducing an opening degree of the discharge port as a rotation speed of the rotor increases is provided in the second flow path.

### CROSS-REFERENCE TO RELATED APPLICATION

This application claims priority on Japanese Patent Application No. 2018-012537, filed Jan. 29, 2018, the entire contents of which are incorporated herein by reference.

### BACKGROUND OF THE INVENTION

### Technical Field

The present invention relates to a rotating electrical machine.

### Background Art

In a rotating electrical machine mounted on a hybrid vehicle, an electric vehicle, or the like, a current supplied to a coil forms a magnetic field in a stator core, and magnetic attractive force and repulsive force are generated between permanent magnets of a rotor and the stator core. In this way, the rotor rotates relative to a stator.

In a rotating electrical machine, a copper loss increases in a high torque state and thus a coil tends to generate heat easily. On the other hand, in a high rotation speed state, an iron loss increases and thus a rotor core, a stator core, and the like tend to generate heat easily. Therefore, for example, Japanese Unexamined Patent Application, First Publication No. 2008-263753 (hereinafter referred to as Patent Document 1) discloses a configuration including a first supply pipe for supplying a large amount of refrigerant to a coil, and a second supply pipe for supplying a large amount of refrigerant to a stator core. In the invention of Patent Document 1, a flow of the refrigerant is switched to either of the first supply pipe or the second supply pipe on the basis of a rotation speed and a torque of a rotating electrical machine.

### SUMMARY OF THE INVENTION

However, in the configuration of Patent Document 1 described above, since the flow of the refrigerant is switched by a switching valve, there has been a possibility that the configuration becomes complicated.

Aspects of the present invention have been made in view of the above circumstances, and it is an object of the present invention to provide a rotating electrical machine that can exhibit excellent cooling performance with a simple configuration.

In order to solve the above problem and achieve the object, the present invention adopts the following aspects.

(1) A rotating electrical machine according to one aspect of the present invention includes: a tubular stator on which a coil is mounted; a rotor which is configured to be rotatable on an inner side in a radial direction with respect to the stator and has a rotor inner flow path through which a refrigerant can flow; and a refrigerant supply flow path which is provided in the rotor and through which a refrigerant flows from an inner side to an outer side in the radial direction as the rotor rotates, and the refrigerant supply flow path includes: a first flow path which communicates with the rotor inner flow path; and a second flow path which extends from the first flow path to an outer side in the radial direction and has a discharge port opening at an end portion in an axial direction of the rotor, wherein a refrigerant adjustment section which adjusts a discharge amount of the refrigerant discharged from the discharge port by reducing an opening degree of the discharge port as a rotation speed of the rotor increases is provided in the second flow path.

(2) In the above aspect (1), the rotor may include a rotor core which has a magnet holding hole for holding a magnet, and an end face plate which is disposed opposite to an end face facing the axial direction of the rotor core and covers the magnet holding hole, and the refrigerant supply flow path may be provided in the end face plate.

(3) In the above aspect (1) or (2), the refrigerant adjustment section may include a valve body which is provided in the second flow path and which is capable of opening and closing the discharge port, and a biasing member which biases the valve body in a direction away from the discharge port.

(4) In the above aspect (1) or (2), the refrigerant adjustment section may include a valve body which is provided in the second flow path and which is capable of opening and closing the discharge port, and a guide portion which guides the valve body toward the discharge port in the second flow path.

(5) In any one of the above aspects (1) to (4), a plurality of the refrigerant supply flow paths may be provided at equal intervals in a circumferential direction of the rotor.

(6) In any one of the above aspects (1) to (5), the discharge port may extend in a direction opposite to a rotation direction of the rotor as it goes from an upstream side thereof to a downstream side thereof.

According to the above aspect (1), the refrigerant adjustment section decreases the opening degree of the discharge port as the rotation speed of the rotor increases. Therefore, in a low rotation state, after the refrigerant having passed through the first flow path flows through the second flow path, it is discharged through the discharge port formed at the end portion in the axial direction. As a result, the refrigerant is actively supplied to the portion (coil end portion) of the coil that protrudes in the axial direction from the stator core through the discharge port.

On the other hand, in a high rotation state, the opening degree of the discharge port decreases, so that the refrigerant flowing through the first flow path actively flows into the inner flow path of the rotor. Therefore, an amount of the refrigerant supplied to the rotor and the stator (coil end portion) can be adjusted according to the rotation speed of the rotor. In particular, in this embodiment, excellent cooling performance can be exerted with a simple configuration as compared with a configuration in which a flow of a refrigerant is switched by a switching valve as in the related art.

According to the above aspect (2), the configuration can be simplified and the maintenance characteristics can be improved as compared with the case where the refrigerant supply path is formed in the rotor core or the like.

According to the above aspect (3), the centrifugal force acting on the valve body exceeds the biasing force of the biasing member, thereby the discharge port being closed by the valve body. On the other hand, when the rotation speed decreases in a state where the discharge port is closed by the valve body, the valve body is separated from the discharge port by the biasing force of the biasing member. As a result, the discharge port is opened again. In this way, since the valve body is biased by the biasing member in a direction away from the discharge port, it is possible to restrain the valve body from remaining in a state of being in close contact with the opening edge of the discharge port when the rotation speed decreases. Therefore, the responsiveness of the refrigerant adjustment section can be improved.

According to the above aspect (4), since the valve body is separated from the discharge port in the low rotation state, the refrigerant flowing through the second flow path is discharged outside of the rotor through the discharge port.

On the other hand, the centrifugal force increases in the high rotation state, so that in the refrigerant flowing through the first flow path, there is more of the refrigerant flowing into the second flow path than of the refrigerant flowing into the rotor inner flow path. Then, as the pressure in the second flow path increases, the valve body is pushed toward the downstream side. At this time, the valve body closes the discharge port by moving along the guide portion. Therefore, the discharge amount of the refrigerant passing through the discharge port is reduced, and the refrigerant is actively supplied to the inner flow path of the rotor.

In this case, it is unnecessary to use a biasing member or the like, so that it is possible to reduce the number of parts and to simplify the configuration.

According to the aspect (5), by providing a plurality of refrigerant supply flow paths, it becomes possible to supply the refrigerant to the stator (coil end portion) and the rotor from a plurality of positions in the circumferential direction. Therefore, the cooling performance can be improved.

According to the above aspect (6), since the discharge port extends in the direction opposite to the rotational direction of the rotor as it goes from the upstream side to the downstream side, it is possible to lower the discharge speed of the refrigerant discharged through the discharge port as compared with the case where the discharge port is formed to be in a straight line or to be inclined in the rotation direction. Therefore, it is possible to restrain the refrigerant from colliding with the stator (coil end portion) and scattering and to keep the refrigerant at the coil end portion. As a result, it is possible to further improve the cooling performance.

### BRIEF DESCRIPTION OF THE DRAWINGS

FIG. 1 is a schematic configuration diagram of a rotating electrical machine according to a first embodiment.

FIG. 2 is a partial cross-sectional view of the rotating electrical machine according to the first embodiment.

FIG. 3 is a partial cross-sectional view of the rotating electrical machine according to the first embodiment.

FIG. 4 is a partial front view of a rotating electrical machine according to a modification of the first embodiment.

FIG. 5 is a partial cross-sectional view of a rotating electrical machine according to a second embodiment.

FIG. 6 is a partial cross-sectional view of the rotating electrical machine according to the second embodiment.

FIG. 7 is a partial cross-sectional view of a rotating electrical machine according to a third embodiment.

FIG. 8 is a partial cross-sectional view of the rotating electrical machine according to the third embodiment.

### DETAILED DESCRIPTION OF THE INVENTION

Embodiments of the present invention will be described below with reference to the drawings.

### First Embodiment

[Rotating Electrical Machine]

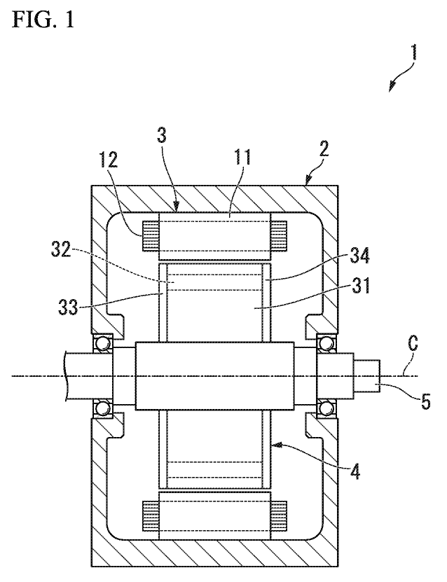

FIG. 1 is a schematic configuration diagram (cross-sectional view) showing an overall configuration of a rotating electrical machine 1 according to a first embodiment.

The rotating electrical machine 1 shown in FIG. 1 is a traction motor mounted on a vehicle such as a hybrid car, an electric car, or the like. However, the configuration of the present invention is applicable not only to a traction motor, but also to a power generation motor, a motor for other purposes, and a rotating electrical machine (including a generator) other than for a vehicle.

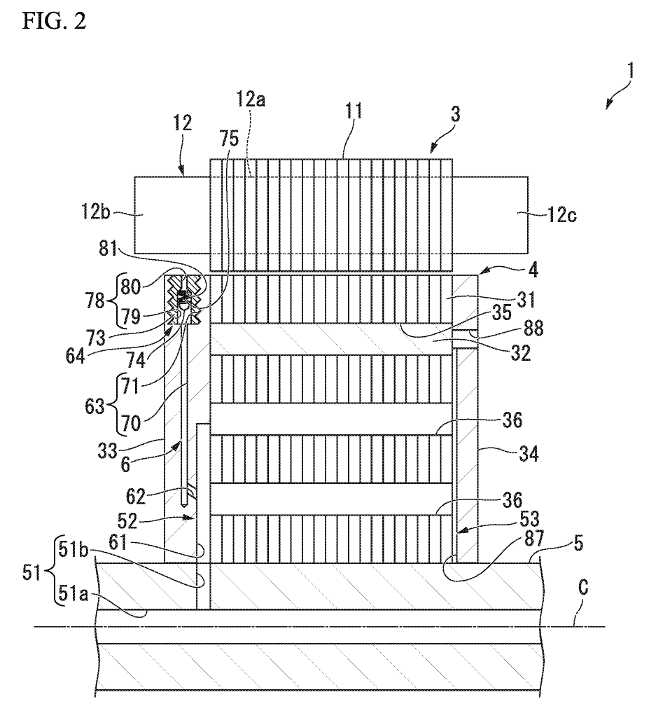

The rotating electrical machine 1 includes a case 2, a stator 3, a rotor 4, an output shaft 5, and a refrigerant supply mechanism 6 (see FIG. 2).

The case 2 accommodates the stator 3, the rotor 4 and the output shaft 5. A refrigerant (not shown) is accommodated in the case 2. The stator 3 described above is disposed such that a part thereof is immersed in the refrigerant in the case 2. As a refrigerant, automatic transmission fluid (ATF), which is a working oil used for lubrication or power transmission of a transmission, or the like is suitably used.

The output shaft 5 is rotatably supported by the case 2. In the following description, a direction along an axis C of the output shaft 5 may be simply referred to as an axial direction, a direction orthogonal to the axis C may be referred to as a radial direction, and a direction around the axis C may be referred to as a circumferential direction.

FIG. 2 is a partial cross-sectional view of the rotating electrical machine 1.

The stator 3 includes a stator core 11 and a coil 12 attached to the stator core 11.

The stator core 11 has a tubular shape disposed coaxially with the axis C. The stator core 11 is fixed to an inner circumferential surface of the case 2. The stator core 11 is configured by laminating electromagnetic steel plates in the axial direction. Also, the stator core 11 may be a so-called dust core.

The coil 12 is mounted on the stator core 11. The coil 12 has a U-phase coil, a V-phase coil and a W-phase coil which are disposed with a phase difference of 120° in the circumferential direction. The coil 12 has an insertion portion 12a which is inserted through a slot (not shown) of the stator core 11, and coil end portions 12b and 12c which protrude in the axial direction from the stator core 11. A magnetic field is generated in the stator core 11 as a current flows through the coil 12.

The rotor 4 is disposed on a radially inner side with respect to the stator 3 with a gap therebetween. The rotor 4 is fixed to the output shaft 5 and is configured to be rotatable integrally with the output shaft 5 around the axis C. Particularly, the rotor 4 mainly includes a rotor core 31, permanent magnets 32, and end face plates (a first end face plate 33 and a second end face plate 34).

The rotor core 31 is formed in a tubular shape disposed coaxially with the axis C. The output shaft 5 is press-fitted and is fixed inside the rotor core 31. Similarly to the stator core 11, the rotor core 31 may be configured by laminating electromagnetic steel plates in the axial direction, or may be a dust core.

A magnet holding hole 35 which penetrates the rotor core 31 in the axial direction is formed in an outer circumferential portion of the rotor core 31. A plurality of magnet holding holes 35 are formed at intervals in the circumferential direction. The permanent magnet 32 is inserted in each magnet holding hole 35. Through holes (rotor inner flow paths) 36 which penetrate the rotor core 31 in the axial direction are formed in an inner circumferential portion of the rotor core 31. A plurality of through holes 36 are formed at intervals in the circumferential direction and the radial direction.

The first end face plate 33 is disposed on a first side in the axial direction with respect to the rotor core 31. The first end face plate 33 covers at least the magnet holding hole 35 in the rotor core 31 from the first side in the axial direction while press-fitted and fixed to the output shaft 5.

The second end face plate 34 is disposed on a second side in the axial direction with respect to the rotor core 31. The second end face plate 34 covers at least the magnet holding hole 35 in the rotor core 31 from the second side in the axial direction while press-fitted and fixed to the output shaft 5.

<Refrigerant Supply Mechanism>

The refrigerant supply mechanism 6 supplies the refrigerant delivered by driving of a refrigerant pump to the stator 3, the rotor 4, and the like. Also, the refrigerant pump may be a so-called mechanical pump that is driven in conjunction with the rotation of the output shaft 5, or may be an electric pump that is driven independently of the rotation of the output shaft 5.

The refrigerant supply mechanism 6 includes a shaft flow path 51, a first end face plate flow path 52, and a second end face plate flow path 53.

The shaft flow path 51 includes an inner flow path 51a and a communication flow path 51b.

The inner flow path 51a extends in the axial direction at a position which is coaxial with the axis C in the output shaft 5. In the inner flow path 51a, a refrigerant delivered from the refrigerant pump flows along the axial direction.

The communication flow path 51b is formed at a position which is equivalent to the position of the first end face plate 33 in the axial direction on the output shaft 5. The communication flow path 51b extends in the radial direction of the output shaft 5. A radially inner end portion of the communication flow path 51b communicates with an inside of the inner flow path 51a. A radially outer end portion of the communication flow path 51b opens on an outer circumferential surface of the output shaft 5. The refrigerant flowing in the inner flow path 51a flows into the communication flow path 51b.

The first end face plate flow path 52 causes the refrigerant flowing in from the communication flow path 51b to flow from an inner side to an outer side in the radial direction due to a centrifugal force caused by the rotation of the rotor 4. Particularly, the first end face plate flow path 52 generally includes a rotor inlet flow path (a first flow path) 61, a branch flow path (a second flow path) 62, a stator supply path (a second flow path) 63, and a refrigerant adjustment section 64.

The rotor inlet flow path 61 extends in the radial direction of the first end face plate 33. A radially inner end portion of the rotor inlet flow path 61 communicates with an inside of the communication flow path 51b described above. That is, the refrigerant flowing through the communication flow path 51b flows into the rotor inlet flow path 61. A radially outer end portion of the rotor inlet flow path 61 terminates on a radially inner side of the magnet holding hole 35 in the first end face plate 33.

The rotor inlet flow path 61 opens on a surface of the first end face plate 33 facing the rotor core 31. The rotor inlet flow path 61 communicates with an inside of the through hole 36 described above. The refrigerant flowing in the rotor inlet flow path 61 can flow into the through hole 36 in the process of flowing outward in the radial direction. That is, the through hole 36 also functions as a cooling passage for cooling the rotor core 31.

The branch flow path 62 branches off from a midway portion of the rotor inlet flow path 61. The branch flow path 62 extends outward in the radial direction as it goes toward the first side in the axial direction. Also, a position connecting between the branch flow path 62 and the rotor inlet flow path 61 can be appropriately changed.

The stator supply path 63 is connected to a downstream end portion (a radially outer end portion) of the branch flow path 62. The stator supply path 63 extends outward in the radial direction in the first end face plate 33. An enlarged diameter portion 71 which is enlarged in diameter as compared with a radially inner end portion (hereinafter referred to as a small diameter portion 70) is formed at a radially outer end portion of the stator supply path 63. The enlarged diameter portion 71 opens on an outer circumferential surface of the first end face plate 33. Also, for example, a female screw portion is formed on an inner circumferential surface of the enlarged diameter portion 71.

The refrigerant adjustment section 64 includes a discharge tube 73, a valve body 74, and a biasing member 75.

A male screw portion is formed on an outer circumferential surface of the discharge tube 73. The discharge tube 73 is screwed into the enlarged diameter portion 71 with its opening direction directed in the radial direction. However, a method of attaching the refrigerant adjustment section 64 to the first end face plate 33 can be appropriately changed. For example, the refrigerant adjustment section 64 (the discharge tube 73) may be fitted into the enlarged diameter portion 71.

An interior of the discharge tube 73 constitutes a discharge flow path 78 from which the refrigerant is discharged. The discharge flow path 78 has a valve body accommodating portion 79 which is positioned on an inner side in the radial direction and a discharge port 80 which is connected on an outer side in the radial direction to the valve body accommodating portion 79.

A valve seat portion 81 which gradually decreases in diameter toward an outer side in the radial direction is formed at a radially outer end portion of the valve body accommodating portion 79.

The discharge port 80 has a radially outer end portion opening on the outer circumferential surface of the first end face plate 33. That is, the discharge port 80 faces the coil end portion 12b in the radial direction. However, the discharge port 80 may not face the coil end portion 12b.

In the present embodiment, the discharge port 80 is formed to have a uniform inner diameter over all portions in the radial direction. However, the discharge port 80 may have a configuration in which the inner diameter changes (for example, decreases) as it goes outward in the radial direction.

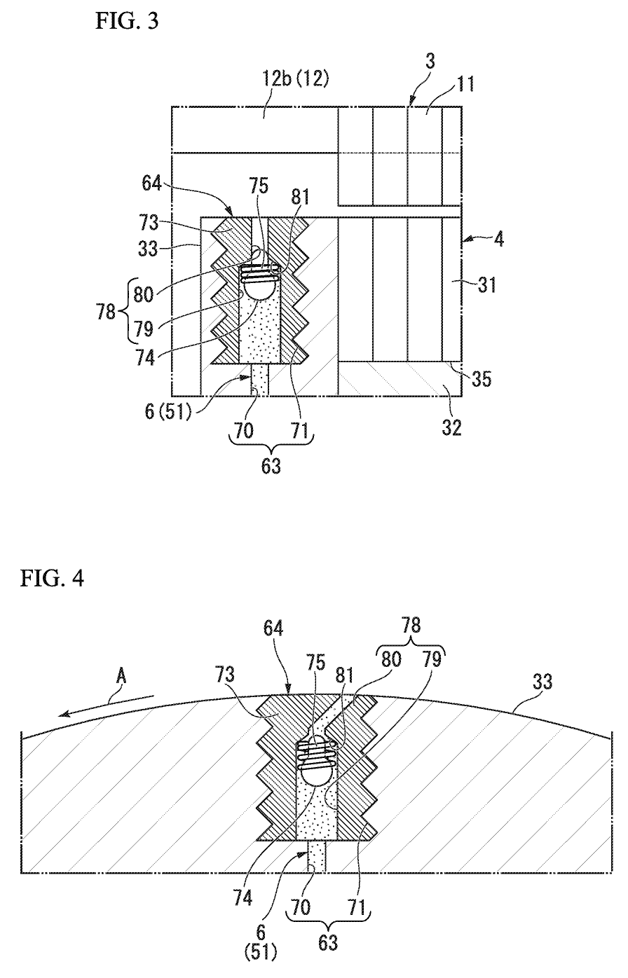

The valve body 74 is accommodated in the aforementioned valve body accommodating portion 79 and is configured to be able to come into contact with and separate from the valve seat portion 81. That is, the valve body 74 blocks communication between the inside of the valve body accommodating portion 79 and the inside of the discharge port 80 in a contact state (see FIG. 3) in which it is in contact with the valve seat portion 81. The valve body 74 allows communication between the inside of the valve body accommodating portion 79 with the inside of the discharge port 80 in a separated state in which it is separated from the valve seat portion 81.

The biasing member 75 is interposed between the valve seat portion 81 and the valve body 74 and biases the valve body 74 in a direction of separating the valve body 74 from the valve seat portion 81 (the separated state described above). Also, the refrigerant adjustment section 64 may be configured not to have the biasing member 75.

The second end face plate flow path 53 discharges the refrigerant flowing inside the rotor 4 from the rotor 4, for example, due to a centrifugal force caused by the rotation of the rotor 4. The second end face plate flow path 53 has a confluence flow path 87 and a rotor outlet flow path 88.

The confluence flow path 87 extends in the radial direction in the second end face plate 34. The confluence flow path 87 opens on a surface of the second end face plate 34 facing the rotor core 31. The confluence flow path 87 communicates with the magnet holding hole 35 and the through hole 36 described above.

The rotor outlet flow path 88 communicates with a radially outer end portion of the confluence flow path 87. The rotor outlet flow path 88 passes through the second end face plate 34 in the axial direction. That is, the confluence flow path 87 described above communicates with the outside of the rotor 4 through the rotor outlet flow path 88.

[Operation]

Next, operations of the rotating electrical machine 1 will be described.

First, a flow of the refrigerant in a low rotation and high torque state will be described. The refrigerant flowing through the inner flow path 51a of the shaft flow path 51 flows into the communication flow path 51b due to the centrifugal force caused by the rotation of the rotor 4. The refrigerant flowing into the communication flow path 51b flows into the communication flow path 51b toward the outer side in the radial direction and then flows into the rotor inlet flow path 61 of the first end face plate flow path 52. In the first end face plate flow path 52, the refrigerant flows from the inner side to the outer side in the radial direction due to the centrifugal force caused by the rotation of the rotor 4.

Among the refrigerant flowing into the rotor inlet flow path 61, some of the refrigerant flows into the through hole 36 in the process of flowing outward in the radial direction in the rotor inlet flow path 61. The refrigerant flowing into the through hole 36 flows through the through hole 36 toward the second side in the axial direction. In this way, the rotor 4 is cooled. The refrigerant that has passed through the through hole 36 flows into the confluence flow path 87. The refrigerant flowing into the confluence flow path 87 flows outward in the radial direction in the confluence flow path 87 and then is discharged to the outside of the rotor 4 through the rotor outlet flow path 88. Further, the refrigerant discharged from the rotor outlet flow path 88 is scattered outward in the radial direction due to the centrifugal force and is supplied to the coil end portion 12c positioned on the second side in the axial direction with respect to the stator core 11. As a result, the coil end portion 12c is cooled.

On the other hand, some of the refrigerant flowing into the rotor inlet flow path 61 flows into the branch flow path 62 in the process of flowing outward in the radial direction in the rotor inlet flow path 61. The refrigerant flowing into the branch flow path 62 flows outward in the radial direction in the branch flow path 62 and then flows into the stator supply path 63 (the small diameter portion 70). The refrigerant flowing into the stator supply path 63 flows outward in the radial direction in the stator supply path 63 and then flows into the valve body accommodating portion 79 of the refrigerant adjustment section 64.

Here, in the low rotation and high torque state, a centrifugal force acting on the valve body 74 is smaller than a biasing force of the biasing member 75. For this reason, the valve body 74 is in the separated state in which it is separated from the valve seat portion 81.

Therefore, the refrigerant flowing into the valve body accommodating portion 79 is discharged outward in the radial direction from the outer circumferential surface of the first end face plate 33 through the discharge port 80.

The refrigerant discharged from the discharge port 80 is scattered to the outside in the radial direction due to the centrifugal force and is supplied to the coil end portion 12b positioned on the first side in the axial direction with respect to the stator core 11. As a result, the coil end portion 12b is cooled.

FIG. 3 is an explanatory diagram of the operation of the rotating electrical machine 1.

Subsequently, an operation in a high rotation and low torque state will be described. As shown in FIG. 3, when the rotor 4 reaches a high rotation state, the centrifugal force acting on the valve body 74 exceeds the biasing force of the biasing member 75. Then, the valve body 74 moves outward in the radial direction in the valve body accommodating portion 79 and is seated on the valve seat portion 81. As a result, communication between the inside of the valve body accommodating portion 79 and the inside of the discharge port 80 is blocked.

When the discharge port 80 is closed by the valve body 74, the discharge of the refrigerant through the discharge port 80 is stopped. For this reason, the refrigerant flowing in the first end face plate flow path 52 flows into the through hole 36 through the rotor inlet flow path 61 to cool the rotor 4. Also, in the above description, although the state in which the discharge port 80 is completely closed in the high rotation and low torque state has been described as an example, the valve body 74 may move closer to the valve seat portion 81 as the rotation speed of the rotor 4 increases, thereby gradually reducing an opening degree of the discharge port 80. That is, the refrigerant adjustment section 64 adjusts a discharge amount of the refrigerant to the stator 3 (the coil end portion 12b) in accordance with the rotation speed of the rotor 4.

As described above, the present embodiment is configured to include the refrigerant adjustment section 64 which reduces the opening degree of the discharge port 80 as the rotation speed of the rotor 4 increases.

According to this configuration, by opening and closing the discharge port 80 using the centrifugal force acting on the valve body 74, the opening degree of the discharge port 80 changes in accordance with the rotation speed of the rotor 4. As a result, in the low rotation and high torque state, the refrigerant is positively discharged to the coil end portion 12b through the discharge port 80. On the other hand, in the high rotation and low torque state, the opening degree of the discharge port 80 becomes small, so that the refrigerant positively flows into the rotor 4 through the through hole 36. Therefore, a supply amount of the refrigerant to the rotor 4 and the coil end portion 12b can be adjusted in accordance with the rotation speed of the rotor 4. Particularly, in the present embodiment, superior cooling performance can be exhibited with a simple configuration, as compared with a configuration in which a flow of a refrigerant is switched by a switching valve as in the related art.

The present embodiment is configured such that the first end face plate flow path 52 which becomes the refrigerant supply flow path is provided on the first end face plate 33.

According to this configuration, as compared with a case where a refrigerant supply path is formed in the rotor core 31 or the like, the configuration can be simplified and the maintenance property can be improved.

The present embodiment is configured such that the refrigerant adjustment section 64 includes the valve body 74 and the biasing member 75 that biases the valve body 74 in a direction of being separated from the discharge port 80.

According to this configuration, when the centrifugal force acting on the valve body 74 exceeds the biasing force of the biasing member 75, the discharge port 80 is closed by the valve body 74. On the other hand, when the rotation speed decreases in a state in which the discharge port 80 is closed by the valve body 74, the valve body 74 is separated from the discharge port 80 by the biasing force of the biasing member 75. As a result, the discharge port 80 opens again. In this way, since the valve body 74 is biased by the biasing member 75 in a direction of being separated from the discharge port 80, it is possible to restrain the valve body 74 from remaining in a state of being in close contact with the valve seat portion 81 when the rotation speed decreases. Therefore, responsiveness of the refrigerant adjustment section 64 can be improved.

### First Modification

In the embodiment described above, the configuration in which only one first end face plate flow path 52 is provided has been described, but the configuration is not limited to this configuration. A plurality of first end face plate flow paths 52 may be provided at intervals in the circumferential direction. In this case, it is preferable to provide the first end face plate flow paths 52 at regular intervals, for example, every 90° or every 120°.

In this way, by providing a plurality of first end face plate flow paths 52, it becomes possible to supply the refrigerant to the stator 3 (coil end portion 12b) and the rotor 4 from a plurality of positions in the circumferential direction. Therefore, the cooling performance can be improved.

### Second Modification

In the above-described embodiment, the configuration in which the discharge port 80 linearly extends in the radial direction at the first side end portion in the axial direction of the rotor 4 has been described, but the configuration is not limited to this configuration. For example, as shown in FIG. 4, it may be inclined in the circumferential direction as it goes outward in the radial direction. In this case, it is preferable to set an inclination direction of the discharge port 80 in a direction opposite to the rotation direction of the rotor 4 (the direction of the arrow A in FIG. 4). This makes it possible to lower the discharge speed of the refrigerant discharged through the discharge port 80 as compared with the case where the discharge port 80 is in a straight line or is inclined in the rotation direction. Therefore, it is possible to restrain the refrigerant from colliding with the coil end portion 12b and scattering, and to keep the refrigerant at the coil end portion 12b. As a result, it is possible to further improve the cooling performance

In the above-described embodiment, the case where the refrigerant adjustment section 64 is provided on the first end face plate 33 has been described, but the present invention is not limited to this configuration, and at least one of the first end face plate 33 and the second end face plate 34 may be provided with a refrigerant adjustment section 64.

In the above-described embodiment, the first end face plate flow path 52 serving as the refrigerant supply flow path is provided in the first end face plate 33, but the present invention is not limited to this configuration, and a partial refrigerant supply flow path may be provided in a portion other than the first end face plate 33, such as the rotor core 31 or the like.

### Second Embodiment

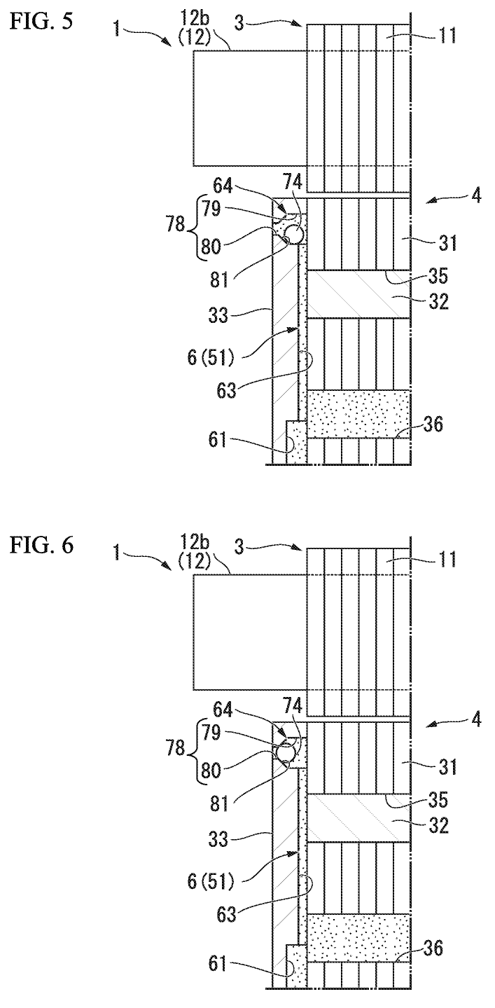

Next, a second embodiment according to the present invention will be described. This embodiment is different from the above-described embodiment in that opening and closing of the discharge port 80 is performed without using a biasing member. FIG. 5 is a partial cross-sectional view of the rotating electrical machine 1 according to the second embodiment. In the following description, the same reference numerals are given to components the same as those of the above-described first embodiment, and description thereof will be omitted as appropriate.

In the rotating electrical machine 1 shown in FIG. 5, the stator supply path 63 is connected to the outer end portion in the radial direction in the rotor inlet flow path 61. The radially outer end portion of the stator supply path 63 terminates at the outer circumferential portion of the first end face plate 33.

The discharge flow path 78 is connected to the radially outer end portion of the stator supply path 63 and extends in the axial direction. Specifically, the valve body accommodating portion 79 of the discharge flow path 78 is provided with a valve seat portion (guide portion) 81 which gradually decreases in diameter toward the first side in the axial direction at a first side end portion in the axial direction.

The discharge port 80 extends from the valve body accommodating portion 79 toward the first side in the axial direction and opens on a first side end face in the axial direction of the first end face plate 33. In the present embodiment, the valve body 74 and the discharge flow path 78 constitute the refrigerant adjustment section 64.

According to this configuration, the valve body 74 is separated from the valve seat portion 81 at the time of low rotation. Therefore, the refrigerant flowing into the valve body accommodating portion 79 through the stator supply path 63 is discharged to the outside of the rotor 4 through the discharge port 80. The refrigerant discharged from the discharge port 80 is supplied to the coil end portion 12b by scattering outward in the radial direction due to a centrifugal force.

On the other hand, as shown in FIG. 6, since the centrifugal force increases at the time of high rotation, among the refrigerant flowing through the rotor inlet flow path 61, the refrigerant flowing into the stator supply path 63 is larger than the refrigerant flowing into the through hole 36. Then, as the pressure in the valve body accommodating portion 79 increases, the valve body 74 is pushed toward the downstream side (the first side in the axial direction). At this time, the valve body 74 moves to the first side in the axial direction along the valve seat portion 81. That is, the valve body 74 moves toward the center of the valve body accommodating portion 79 as it goes toward the first side in the axial direction. Thereafter, the valve body 74 comes into close contact with the entire circumference of the valve seat portion 81, whereby the discharge port 80 is closed. Therefore, most of the refrigerant flowing through the first end face plate flow path 52 flows into the through hole 36.

In this embodiment, in addition to the same operations and effects as in the above-described first embodiment, it is not necessary to use the biasing member 75 or the like, so that the number of parts can be reduced and the configuration can be simplified.

In addition, compared with the case where the biasing member 75 is used, the thickness of the first end face plate 33 can be reduced.

### Third Embodiment

Next, a third embodiment according to the present invention will be described. This embodiment is different from the above-mentioned embodiment in that the biasing member 100 is formed in a leaf spring shape.

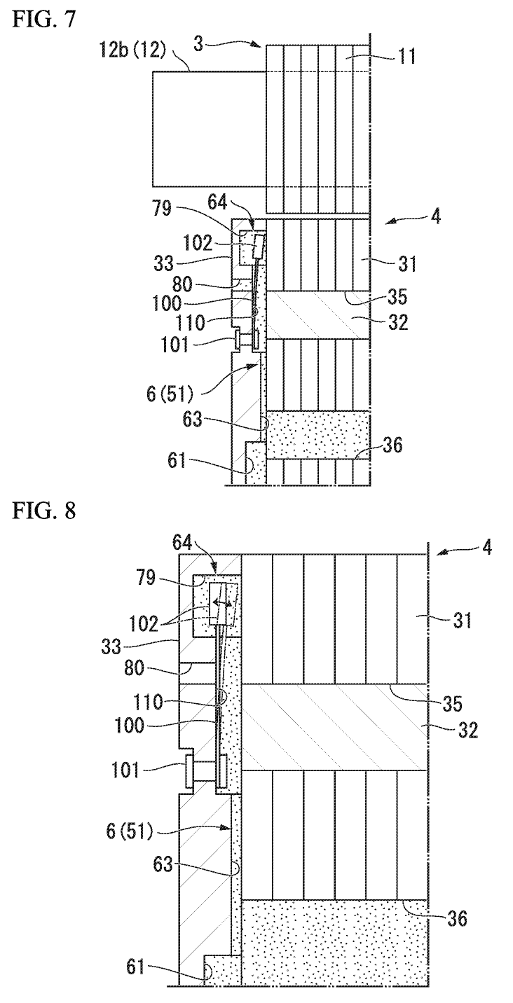

In the rotating electrical machine 1 shown in FIG. 7, a biasing member 100 is provided in the valve body accommodating portion 79. The biasing member 100 is formed in a leaf spring shape extending in the radial direction. A radially inner end portion of the biasing member 100 is fixed to the first end face plate 33 using a fixing member 101.

That is, the biasing member 100 is configured to be elastically deformable in the axial direction starting from the inner end portion in the radial direction. A weight portion 102 is provided on a radially outer end portion of the biasing member 100.

On the inner surface of the valve body accommodating portion 79, the facing surface that faces the biasing member 100 in the axial direction constitutes a seating surface 110 which the biasing member 100 is configured to be able to come into contact with and separate from.

The discharge port 80 extends from the valve body accommodating portion 79 toward the first side in the axial direction. The first side end portion in the axial direction of the discharge port 80 opens on the first side end face in the axial direction of the first end face plate 33. On the other hand, the second axial end portion of the discharge port 80 opens on the seating surface 110. The biasing member 100 described above blocks communication between the inside of the valve body accommodating portion 79 and the inside of the discharge port 80 in the contact state in contact with the seating surface 110. On the other hand, the biasing member 100 communicates the inside of the valve body accommodating portion 79 with the inside of the discharge port 80 in a separated state in which it separates from the seating surface 110. That is, the biasing member 100 of the present embodiment also has the function of the valve body. In the present embodiment, the refrigerant adjustment section 64 includes the valve body accommodating portion 79, the biasing member 100, the weight portion 102, and the like.

According to the present embodiment, the biasing member 100 is separated from the seating surface 110 at the time of low rotation.

Therefore, the refrigerant flowing into the valve body accommodating portion 79 through the stator supply path 63 is discharged to the outside of the rotor 4 through the discharge port 80. The refrigerant discharged from the discharge port 80 is supplied to the coil end portion 12b by scattering outward in the radial direction due to a centrifugal force.

On the other hand, as shown in FIG. 8, since the centrifugal force increases at the time of high rotation, the refrigerant flowing into the stator supply path 63 among the refrigerant flowing through the rotor inlet flow path 61 is larger than the refrigerant flowing into the through hole 36. Then, the centrifugal force acting on the biasing member 100 and the weight portion 102 exceeds the biasing force of the biasing member 100, so that the biasing member 100 elastically deforms to the first side in the axial direction starting from the inner end portion in the radial direction. As a result, the biasing member 100 is seated on the seating surface 110, and the discharge port 80 is closed. Therefore, most of the refrigerant flowing through the first end face plate flow path 52 flows into the through hole 36.

In the present embodiment, by using the leaf spring-like biasing member 100 which has the same action and effects as the above-described embodiment and is elastically deformable in the axial direction, the thickness of the first end face plate 33 can be reduced.

Although preferred embodiments of the present invention have been described above, the present invention is not limited to these examples. Additions, omissions, substitutions, and other changes in the configuration are possible without departing from the spirit of the present invention. The invention is not limited by the foregoing description, and is only limited by the scope of the appended claims.

For example, in the above-described embodiment, the case where the refrigerant is supplied through the shaft flow path 51 formed in the output shaft 5 has been described, but the present invention is not limited to this configuration. The refrigerant may be supplied to a refrigerant supply path through a supply port provided in the case 2 or the like.

Besides, within the scope not deviating from the spirit of the present invention, it is possible to replace the constituent elements in the above-mentioned embodiment by well-known constituent elements as appropriate, and the above-described modified examples may be appropriately combined.

What is claimed is:

1. A rotating electrical machine, comprising:
a tubular stator on which a coil is mounted;
a rotor which is configured to be rotatable on an inner side in a radial direction with respect to the stator and has a rotor inner flow path through which a refrigerant can flow; and
a refrigerant supply flow path which is provided in the rotor and through which a refrigerant flows from an inner side to an outer side in the radial direction as the rotor rotates,
the refrigerant supply flow path including:
a first flow path which communicates with the rotor inner flow path; and
a second flow path which extends from the first flow path to an outer side in the radial direction and has a discharge port opening at an end portion in an axial direction of the rotor,
wherein a refrigerant adjustment section which adjusts a discharge amount of the refrigerant discharged from the discharge port by reducing an opening degree of the discharge port as a rotation speed of the rotor increases is provided in the second flow path.

2. The rotating electrical machine according to claim 1,
wherein the rotor includes:
a rotor core which has a magnet holding hole for holding a magnet; and
an end face plate which is disposed opposite to an end face facing the axial direction of the rotor core and covers the magnet holding hole, and
the refrigerant supply flow path is provided in the end face plate.

3. The rotating electrical machine according to claim 1,
wherein the refrigerant adjustment section includes:
a valve body which is provided in the second flow path and which is capable of opening and closing the discharge port; and
a biasing member which biases the valve body in a direction away from the discharge port.

4. The rotating electrical machine according to claim 1,
wherein the refrigerant adjustment section includes:
a valve body which is provided in the second flow path and which is capable of opening and closing the discharge port; and
a guide portion which guides the valve body toward the discharge port in the second flow path.

5. The rotating electrical machine according to claim 1, wherein a plurality of the refrigerant supply flow paths are provided at equal intervals in a circumferential direction of the rotor.

6. The rotating electrical machine according to claim 1, wherein the discharge port extends in a direction opposite to a rotation direction of the rotor as it goes from an upstream side thereof to a downstream side thereof.
